(19) United States
(12) Patent Application Publication
(10) Pub. No.: US 2010/0235177 A1
(43) Pub. Date: Sep. 16, 2010

(54) REMOTE PATIENT MANAGEMENT PLATFORM WITH ENTERTAINMENT COMPONENT

(75) Inventors: Hans-Aloys Wischmann, Henstedt-Ulzburg (DE); Jelle van der Weijde, Hendrik Ido Ambacht (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/305,702

(22) PCT Filed: Jul. 2, 2007
(86) PCT No.: PCT/US07/72644

§ 371 Date: Dec. 19, 2008

Related U.S. Application Data
(60) Provisional application No. 60/806,644, filed on Jul. 6, 2006.

(51) Int. Cl. G06Q 50/00; A63F 9/24; G06Q 10/00; G06F 3/01

(52) U.S. Cl. 705/2; 463/1; 715/733

(57) ABSTRACT

An entertainment server (80) stores entertainment content sessions (130, 132). A user interface (48) is configured for presenting the entertainment content sessions (130, 132) to a user.

The present application relates to the health management arts. It finds particular application in conjunction with the patient care plan optimization and will be described with the particular reference thereto. It also finds application in conjunction with the remote patient monitoring, surveying, and the like.

The outpatient or remote health care management system typically connects chronically ill patients and health care providers via an interactive health care communication platform, which, for example, uses the patient's home television sets. The patients use the medical devices, which are installed in their homes, to measure vital signs such as blood pressure, heart rate and weight. The patient's biometric data is automatically sent via secured television connection links to the supervising health care providers. The health care providers monitor the patient's health by setting up the flags for clinical reviews if one of the vital sign measurements falls outside the normal range. In addition, the health care professionals can support the patients by sending them reminders, educational videos, and the like. The patients access such materials through the home television set.

For example, standardized questionnaires on quality of life or depression, or educational videos on specific disease areas can be translated into many languages, and can be regularly presented to the patients via the TV interface. Due to the standardization of the questionnaires and educational videos, some patients might perceive the presentations as repetitive, and possibly even as boring. As a result, there is a possibility that the patients become demotivated and stop actively participating in the program, which, in turn, would curtail the expected health benefits.

One solution is to interactively provide a large variety of videos and programs. However, since the videos and questionnaires are typically focused on the circumstances of a specific patient's current health status and situation, the number of videos relevant to a specific patient is limited and cannot grow indefinitely.

Another solution is to provide personal messages from the health care providers. However, shortage of health care professionals renders frequent personalized unautomated communications between the patients and health care professionals infeasible.

The present application provides new and improved methods and apparatuses which overcome the above-referenced problems and others.

In accordance with one aspect, a health management system is disclosed. An entertainment server stores entertainment content sessions. A user interface is configured for presenting the entertainment content sessions to a user.

In accordance with another aspect, a health management method is disclosed. Entertainment content sessions are stored. The entertainment content sessions are presented to a user.

In accordance with another aspect, a user interface, accessible by a user, for receiving and sending information to and from a remote station via at least one server is disclosed. A display is configured for presenting an entertainment content session transmitted by the server, the entertainment content session is generated by the server based at least on one of an input from the user interface and an intervention engine and is directed toward achieving a health management goal.

One advantage is that an entertainment component is provided to the patients which provides intellectual stimuli and facilitates monitoring of the mental performance or physical ability of the patients.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

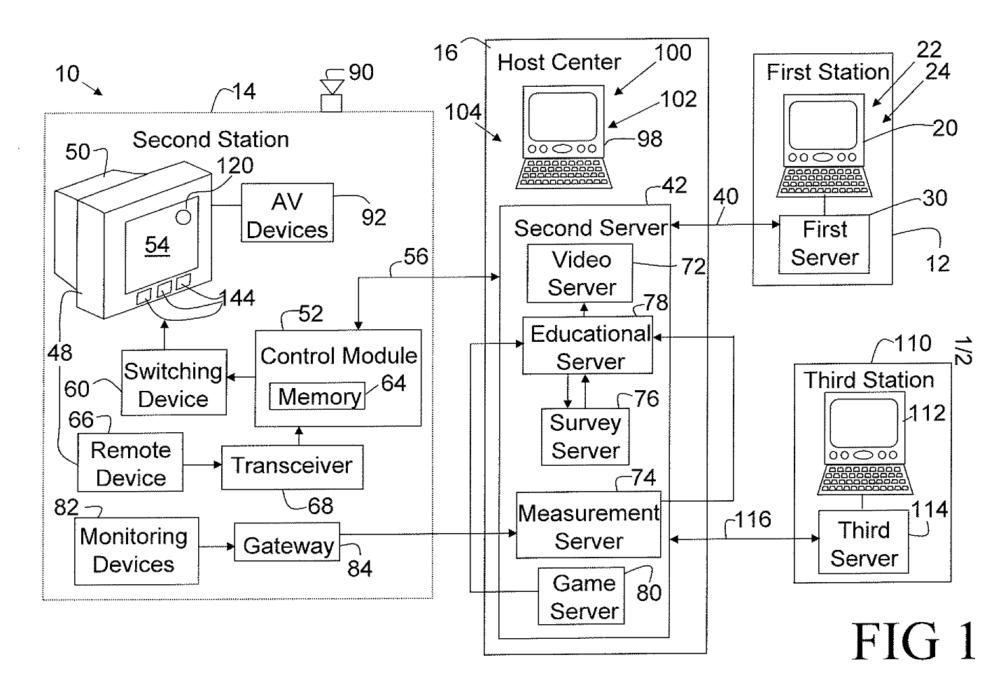

FIG. 1 diagrammatically shows principal components of an example health management system; and

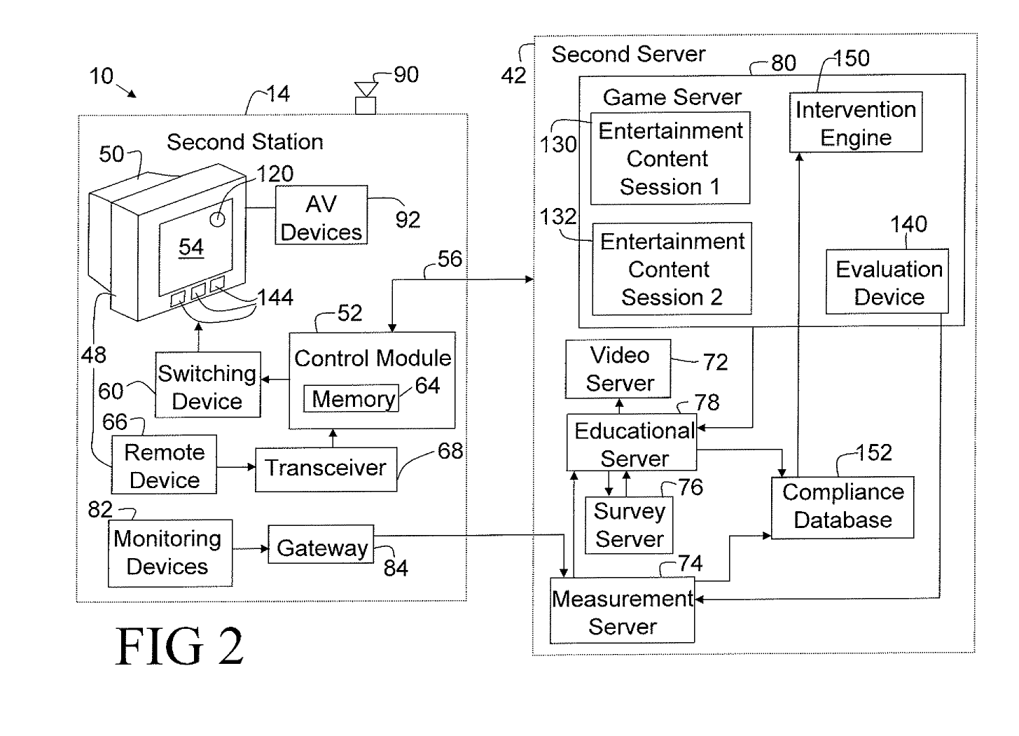

FIG. 2 diagrammatically shows a detailed portion of the health management system.

With reference to FIG. 1, a health management system 10 includes first and second stations 12, 14 and a host center 16. The first or care provider station 12 is located, for example, at a care provider site such as a physician's office or hospital and includes a terminal 20. One example of the terminal 20 is a personal computer which includes appropriate software 22, such as user interface software, and hardware 24, for interfacing with the host center 16 and via the host center 16 with the second station 14. The terminal 20 is connected to a first server 30 via an intranet or other connection as known in the art.

Of course, it is contemplated that the health management system 10 can include a plurality of the first stations 12, a plurality of host centers 16 and a plurality of second stations 14 as appropriate for an application.

A first link 40 provides the connection between the first station 12 and the host center 16. Alternatively, the first station 12 is a wireless station of a wireless local area network (LAN) or wireless wide are network (WAN).

The second or patient station 14 includes a user or patient interface 48 including a television set 50 or other patient display device which is located in a patient's home or dwelling. The user interface 48 further includes a control module, processor, algorithm or other means 52, such as set-top box, which interfaces with a video display 54 of the television set 50. The control module 52 converts and displays data from analog cable, digital cable, satellite, digital subscriber line (DSL), or digital broadcast television to a standard channel frequency, e.g. channel number, for display, for example, on a standard analog television set 50. In another embodiment, the module 52 converts and displays the data directly on the television set 50 via an RCA (Radio Corporation of America) or SCART (Syndicat des Constructeurs d'Appareils Radiorécepteurs et Téléviseurs) connector or interface, without the need to encode the signal onto a television channel frequency. In one embodiment, the control module 52 further receives on or off-air digital or conventional analog television signals from a cable or satellite provider or local broadcast TV for display on a DTV monitor. The control module 52 also receives signals such as digital or analog television format signals and patient information signals from the host center 16 via a second link 56. The examples of the second link 56 are wired connection, wireless connection, satellite connection, fiber optic connection, and the like.

The control module 52 is connected to the video display 54 via a switching device, algorithm or means 60 such as an audio/video (AV) switching device as known in the art. The switching device 60 provides switching between television reception from the tuner of the display 54 (or VCR, DVD or the like) and patient information reception/transmission from/to the host center 16. Alternatively, any other known type of input device adapted to provide an interface to the video display 54 is used.

For example, the patient information signals include information, instructions and queries that are displayed on the video display for information, action, and the like. The patient information signals include video and audio health issue programs, audio programs, video messages and audio messages, reminders to send health or biometric information, and the like. For example, the control module 52 can include a memory 64 so that patient information signals are stored for later use, e.g. time-shifted display. When the switching device 60 is configured to transmit the patient information signals, the control module 52 retrieves the patient information signals from the memory 64 to the display 54 or forwards the signals as received. The user interface 48 further includes a remote interface device 66 which provides signals to an infrared transceiver 68. Signals from the transceiver 68 are provided to the control module 52 and function to select video input to the video display 54, input patient information, and the like. In one embodiment, the remote interface device 66 is a remote control device such as one commonly used in the home entertainment systems. In another embodiment, the remote interface device 66 is a computer input interface device, such as a keyboard or a mouse.

The host center 16 is centralized and includes various servers for specific functions. The examples of servers of the host center 16 are a video server 72 which provides pertinent video content to the display 54, a measurement server 74 which collects and transfers patient's biometric measurements, a survey server 76 which generates surveys, an educational server 78 which automatically generates and delivers medically oriented educational sessions, a game or entertainment server 80 that generates and delivers the entertainment content, and others. In one embodiment, the educational server 78 performs functions of other servers. In one embodiment, the educational server 78 interacts tightly with other servers to perform combined functions. For example, the educational server 78 initiates a survey, recovers an answer set, stratifies risk and evaluates need for video content, initiates transfer of video content, initiates a quiz, recoveres an answer set, stratifies risk and evaluates learning performance, comfort level, etc., generates and delivers entertainment content, and the like.

It is also contemplated that the host center 16 is distributed, with different components or sub-centers hosting different functions. Alternatively, there may be a plurality of host centers 16 that connect a plurality of second stations 14 with one or more first stations 12.

In one embodiment, the second station 14 includes a set of patient monitoring or biometric devices 82. The examples of the patient monitoring devices 82 include a weight scale, a blood pressure device, an electrocardiogram, an electroencephalogram, an oximeter, a brain wave measuring device, a respiration monitor, a thermometer, and the like. In a typical arrangement, the user is located at a dwelling such as a house, apartment, assisted living apartment, or so forth, and does not have ready access to medical personnel. Accordingly, in some embodiments the biometric devices 82 are advantageously designed to be simple to operate. For example, a fingertip SpO₂ monitor can be used to provide both saturated blood oxygen level and heart rate simply by clipping the fingertip monitor onto the patient's fingertip. The biometric devices can be wireless devices which are worn by the patient and communicate biometric reading continuously or at intervals to the host center, can be cabled devices which the patient uses one or more times a day to take readings, or the like. Additionally, or alternatively, certain measurements may be manually entered by the patient via the remote device 66. Alternatively, the biometric device 82 can be implanted in the patient, such as a sensor on a pacemaker, on an infusion pump, and the like. Collected monitored or manual patient data are provided to a measurement gateway 84, which transmits the data to the measurement server 74 for processing and use.

Other exemplary user interface devices are a personal computer (PC), personal digital assistant (PDA), a mobile phone, a portable computer, automated voice response system and the like. As such, the display is accordingly a computer monitor, handheld communication device display, such as a portable phone, cellular phone or PDA.

In one embodiment, the second station 14 includes an RF interface 90 such as an antenna and audio/video (AV) devices 92 which provide links to the second station 14. The examples of the AV devices 92 are a video cassette recorder (VCR), a digital video disc (DVD) player, a cable box, and the like.

The host center 16 includes a host center terminal 98 including appropriate hardware 100, software 102 and communications links 104 to enable connectivity between the first and second stations 12, 14.

Optionally, the health management system 10 includes an information or third station 110 which provides access to the patient information to the authorized users, such as selected family members and friends, via an access terminal 112 connected to a third server 114. The examples of the access terminal 112 are a personal computer, a video display including a control module, a PDA, a portable computer, a cellular telephone, and the like. The connection of the third station 110 to the host center 16 may be a third link 116 wired or wireless connection.

With continuing reference to FIG. 1 and further reference to FIG. 2, the game server 80 delivers entertainment content to the patient when patient selects, for example, an icon or push button 120 on the display 54. In one embodiment, the selection can be performed by the patient as a response to an indicator, such as a blinking light, that informs the patient about new games/entertainment content. The entertainment content is arranged in entertainment content sessions 130, 132. For example, the entertainment content sessions 130, 132 include games, such as a memory game, where the user is instructed to find pairs of matching image tiles from an n×m array by reversing two tiles at a time. Other games, such as Pac-Man™, Tetris™, card games (solitaire, poker, black jack), chess, checkers, dominos, quest-type games (requiring direction following and choice making), trivia games, and other games that provide mental stimuli, are also contemplated.

In one embodiment, the entertainment content sessions 130, 132 are directed toward different health management goals. For example, different entertainment content sessions 130, 132 may be provided that are directed toward: general education; specialized education; increasing memory; decreasing reaction time; increasing mental capacity; and so forth. The number of entertainment content sessions 130, 132 can vary between one content session, to five, ten, or more content sessions.

An evaluation device, processor, algorithm or means 140 tracks predetermined evaluation criteria such as, for example, the user's reaction times and number of correct/incorrect moves/attempts. The evaluation criteria is transmitted to the measurement server 74 as a “vital parameter data set” at a termination of the game (quit or done) or at specific intervals (moves, time spent). For example, the number of required steps to finish the memory game can be tracked, evaluated in a longitudinal comparison, stored as an indirect measure of mental short-term memory capacity with the patient's other vital parameters and questionnaire responses. As another example, the reaction times may be indicative of the patient's fine motor control/skill. Examples of other evaluation criteria are a game score, a frequency of play, a game type chosen, an elapsed time of game, a deviation in one of the evaluation criteria over time, and the like. Examples of other traits that can be ascertained from such games are hearing, sight, mental acuity (e.g. ability to do simple math, follow simple directions), strength, coordination, and the like.

In one embodiment, an intervention engine 150 generates immediate messages on improvement or encouragement in case of the patient's change in performance that are sent to the patient. The tracked information or a lack of the tracked information might be indicative of the conditions which require intervention. For example, based on the tracked information, it might be perceived that the short term memory capacity of the patient has substantially decreased. As another example, if the evaluation device 140 does not receive any information from the patient for a predetermined period of time, it might be perceived as a serious condition of the patient as, for example, a depression. The intervention engine 150 schedules or initiates an intervention such as a survey, telephone call with the patient or a trusted third party, a visit with the doctor or nurse, and the like. In one embodiment, feedback from the entertainment content sessions 130, 132 is used to adapt a care plan for the user. In another embodiment, in which interactive “virtual” games are unitized, feedback from the entertainment content sessions 130, 132 is used to track movements and/or can be used to interact with monitoring devices, etc. (including respiration devices that show lung capacity)

In one embodiment, the intervention engine 150 controls the presentation of the entrainment content sessions 130, 132 to the patient. More specifically, a compliance database 152 stores the compliance data indicative of the patient's compliance with the prescribed health care plan. E.g., whether the patient answered the survey, performed a scheduled vital sign measurement, watched the prescribed educational video, and the like. The intervention engine 150 compares the compliance data with predetermined compliance criteria to determine the compliance status of the patient. For example, based on the compliance score, the intervention engine 150 allows or blocks the presentation of the entertainment content sessions 130, 132.

In this manner, the entertainment component enriches patient's interaction experience, increases patient's interest in complying with the prescribed medical plan, provides intellectual stimuli to the patient and allows periodic monitoring of cognitive performance with individual patient feedback. An immediate feedback on improvement or degradation from longitudinal comparisons (better than yesterday, but not as good as last week, and so forth) is provided.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

Having thus described the preferred embodiments, the invention is now claimed to be:

1. A health management system (10) comprising:
an entertainment server (80) which stores entertainment content sessions (130, 132); and
a user interface (48) configured for presenting the entertainment content sessions (130, 132) to a user.

2. The health management system as set forth in claim 1, wherein the entertainment content sessions (130, 132) include at least games.

3. The health management system as set forth in claim 1, further including:
an evaluation device (140) which tracks predetermined criteria indicative of at least one of a mental function and a physical ability of the user.

4. The health management system as set forth in claim 3, wherein the entertainment content sessions (130, 132) include at least games and the predetermined criteria includes at least one of:
a number of correct moves in the game,
a number of incorrect moves in the game,
a reaction time of the user,
a game score,
a frequency of play,
a game type chosen,
an elapsed time of game, and
a deviation in at least one tracked predetermined criteria.

5. The health management system as set forth in claim 3, further including:
an intervention engine (150) which, based on one of the tracked predetermined criteria and a lack of the tracked predetermined criteria, one of:
schedules an intervention,
approves a presentation of the entertainment content session, and
blocks a presentation of the entertainment content session.

6. The health management system as set forth in claim 5, wherein the intervention includes at least one of:
generating a message directed to at least one of the user, a health care professional, a care provider and a third party,
generating a survey,
initiating a vital sign measurement, and
initiating a visit with a health care professional.

7. The health management system as set forth in claim 3, further including:
a survey server (76) which generates a survey based on one of the tracked predetermined criteria and a lack of the tracked predetermined criteria, which survey is sent to at least one of the user and a third party.

8. The health management system as set forth in claim 7, wherein the survey includes:
a survey, quiz, test, or questionnaire including at least one question presented by the user interface (48), the at least one input including a user response via a user interface (48).

9. The health management system as set forth in claim 1, further including:
a biometric device (82) which acquires biometric data of the user.

10. The health management system as set forth in claim 1, feedback from the entertainment content sessions (130, 132) is used to adapt a care plan for the user.

11. A health management system including:
a host center (16) which includes the entertainment server (80) as set forth in claim 1; and
a plurality of patient stations (14) each connected with the host center (16) to select the entertainment content session (130, 132).

12. A health management method comprising:
storing entertainment content sessions (130, 132); and
presenting the entertainment content sessions (130, 132) to a user.

13. The method as set forth in claim 12, wherein the entertainment content sessions (130, 132) include at least games.

14. The method as set forth in claim 12, further including:
tracking predetermined criteria indicative of at least one of a mental function and a physical ability of the user.

15. The method as set forth in claim 14, wherein the entertainment content sessions (130, 132) include at least games and the predetermined criteria includes at least one of:
a number of correct moves in the game,
a number of incorrect moves in the game,
a reaction time of the user,
a game score,
a frequency of play,
a game type chosen,
an elapsed time of game, and
a deviation in at least one tracked predetermined criteria.

16. The method as set forth in claim 14, further including:
based on one of the tracked predetermined criteria and a lack of the tracked predetermined criteria, one of:
scheduling an intervention,
approving a presentation of the entertainment content session, or
blocking a presentation of the entertainment content session.

17. The method as set forth in claim 16, wherein the step of scheduling the intervention includes at least one of:
generating a message directed to at least one of the user, a health care professional, a care provider and a third party,
generating a survey,
initiating a vital sign measurement, and
initiating a visit with a health care professional.

18. The method as set forth in claim 14, further including:
generating a survey based on one of the tracked predetermined criteria and a lack of the tracked predetermined criteria; and
sending the survey to at least one of the user and a third party.

19. A user interface (48), accessible by a user, for receiving and sending information to and from a remote station (12, 16, 110) via at least one server (42), the user interface (48) comprising:
a display (54), which is configured for presenting an entertainment content session (130, 132) transmitted by the server (42), the entertainment content session (130, 132) is generated by the server (42) based on an input (120) from at least one of the user interface (48) and an intervention engine (150) and is directed toward achieving a health management goal.

20. A user interface as set forth in claim 19, wherein feedback from the entertainment content session (130, 132) is used to adapt a care plan for the user.
